(19) United States
(12) Patent Application Publication
(10) Pub. No.: US 2015/0149609 A1
(43) Pub. Date: May 28, 2015

(54) PERFORMANCE MONITORING TO PROVIDE REAL OR NEAR REAL TIME REMEDIATION FEEDBACK

(71) Applicant: MICROSOFT CORPORATION, REDMOND, WA (US)

(72) Inventors: Cheng Zou, Redmond, WA (US); Dhanasekaran Raju, Bellevue, WA (US); Pravjit Tiwana, Bellevue, WA (US); Olexiy Karpus, Redmond, WA (US)

(73) Assignee: MICROSOFT CORPORATION, REDMOND, WA (US)

(21) Appl. No.: 14/087,413

(22) Filed: Nov. 22, 2013

(51) Int. Cl. H04L 29/08

(52) U.S. Cl. CPC H04L 67/2833
USPC 709/224

(57) ABSTRACT

Embodiments provide for monitoring of an online user experience and/or remediating performance issues, but are not so limited. A computer-implemented method of an embodiment operates to receive, pre-aggregate, and aggregate client performance data as part of providing an end-to-end diagnostics monitoring and resolution service. A system of an embodiment is configured to aggregate performance data of a plurality of client devices or systems as part of identifying latency issues at one or more of a tenant level, geographic location level, and/or service provider level. Other embodiments are included.

### BACKGROUND

Many large and small scale businesses depend on some type of on online service as part of running a successful venture. Bandwidth is one factor that affects speed of a network. Latency is another factor that affects network speed and responsiveness. Latency may be described as delay that affects processing of network data. Network conditions, hardware and software limitations, and/or other factors may adversely affect a user's experience of some online application or service. With the emergence of cloud computing and datacenter services, it is imperative to provide timely service with minimal bottlenecks across hundreds of server computers and associated networking infrastructure serving millions of users worldwide.

One difficulty lies in the complexity associated with monitoring the health of one or more services over multiple geographic locations and multiple diverse components in real or near real time. System downtime and even small amounts of performance degradation can lead to additional man hours, cost, and machine overload, which may potentially affect a business' bottom line. Unfortunately, the current state of the art is deficient in providing performance monitoring and resolution systems that efficiently identify issues and provide robust solutions or feedback as quickly as possible.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide for monitoring of an online user experience and/or remediating performance issues, but are not so limited. A computer-implemented method of an embodiment operates to receive, pre-aggregate, and aggregate client performance data as part of providing an end-to-end diagnostics monitoring and resolution service. A system of an embodiment is configured to aggregate performance data of a plurality of client devices or systems as part of identifying latency issues at one or more of a tenant level, geographic location level, and/or service provider level. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 depicts an exemplary system that operates in part to provide real or near real time end user performance monitoring services.

FIG. 2 is a flow diagram depicting an exemplary process of pre-aggregating and aggregating performance and/or other data.

FIG. 3 is a block diagram depicting components of an exemplary end-to-end data processing pipeline.

FIG. 4 is flow diagram depicting operations of an exemplary end-to-end process used as part of providing performance diagnostic analysis and/or issue remediation services.

FIG. 5 is a block diagram illustrating an exemplary computing environment for implementation of various embodiments.

FIGS. 6A-6B illustrate a mobile computing device with which embodiments may be practiced.

FIG. 7 illustrates one embodiment of a system architecture for implementation of various embodiments.

### DETAILED DESCRIPTION

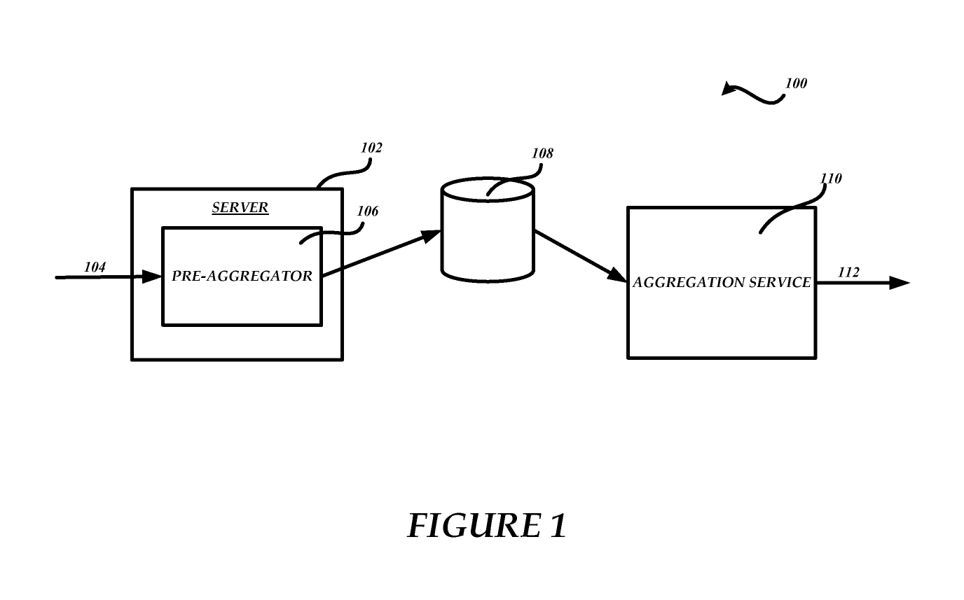

FIG. 1 depicts an exemplary system 100 that operates in part to provide real or near real time end user performance monitoring services, but is not so limited. Components of the system 100 operate in part to use aggregated latency and/or other network data to mitigate and/or resolve network ecosystem issues. As an example, as part of providing an online service, such as providing one or more office productivity applications and/or features of an application suite, components of the system 100 can operate to provide failure zone analysis and resolution information to tenants based on aggregations of performance data. Components of the system 100 can be used to provide a real or near real time assessment of the usability of an online service as well as being able to identify or target failure zones to troubleshoot and/or correct any associated performance or user-experience problems.

As described below, the system 100 includes features that provide end user performance optics to consumers of an online service including quantifying real time tenant level optics, such as by enabling one or more designated persons of a customer with an ability to view performance or other metrics of a user base across any geographical location or locations. For example, components of the system 100 operate in part by collecting tenant level data to identify top latency data or other outliers for reporting or alerting within a defined location of interest. Equipped with an ability to focus at a geographic level can uncover issues specific to location, such as poor CDN performance, DNS resolution time, longer round trip times, etc. Additionally, geographic granularity based on a service provider allows for identifying issues at an Internet Service Provider (ISP) level.

Correspondingly, consumers can use real or near real time feedback to identify users, tenants, and/or locations having degraded or otherwise deficient service experiences. As described briefly above, components of the system 100 can operate to ascertain one or more failure zones for tenants as well as identify specific users having degraded experience. For example, as part of monitoring an end user using an online email service, the aggregation service 110 can use rules to generate an aggregated output 112 to generate a geographic-based latency map color coded by scale of communication latency. The aggregation service 110 can use configured rules to generate an aggregated output 112 as part of debugging and isolating issues based on geographic, ISP, and/or other parameters as described below.

Correspondingly, components of the system 100 operate to identify failure zones, such as by isolating an issue tied to a DNS resolver, ISP peering, network routing, non-optimal hosting locations, etc. For example, components of the system 100 can be used to assess or quantify a state of a user experience for one or more locations (e.g., region, country, county, etc.), one or more tenants, a selected tenant by geographic location or ISP, and/or for selected geographic location by ISP. The system 100 operates in part to provide for debugging of latency or other data with additional breakdowns by: a client time, a network time, a server time, a CDN time, a connect time, etc.; identifying outlier data, such as a first number of tenants and ISPs by latency; generating historic trends on latency and other performance metrics; providing guidance data for effective edge and other server deployments; enabling pre-aggregating by configuring mailbox servers with geo-mapping capability; generating report data to gain insight into real user CDN interaction; supporting web access based and locally installed clients to reduce load times; etc. Depending on the client, different types of metrics or other data can be collected and provided to the system 100 for use in quantifying user experiences.

Components of the system 100 can operate as part of supporting use of an online service or application by proactively operating to identify specific users or user groups having a degraded experience. As described below, as part of assessing a performance state of an online service or application, quantitative comparisons can be made relative to one or more baseline experiences for a particular location or ISP. Establishing robust and up-to-date baselines allows for a more focused and confident response to performance related calls/emails and proactive aspect of identification of outliers can be used to have 360 degree loop with service consumers.

One embodiment of the system 100 comprises a service support communication infrastructure that enables troubleshooting and remedying performance or other issues related to a server component, a client component, and/or a network condition, such as network latency issues, DNS look up issues, Content Delivery Network (CDN) issues, etc. According to one embodiment, data collection services comprise a decentralized architecture which partitions client data based in part on a datacenter location by processing raw client data for each server node including pre-aggregating raw data before uploading pre-aggregated data to one or more stores, such as a plurality of database servers for example, before final aggregations.

Depending on the implementation, the aggregation service 110 can be configured as a separate or an integrated service running on one or multiple physical machines to globally aggregate the pre-aggregated data across multiple data stores based on a set of common and/or customized metrics. By pre-aggregating as part of collecting data at each node, processing time and use can be reduced due in part to the limited number of data points used with a final aggregation. As such, aggregated data can be generated in real or near real time. The aggregation service 110 of one embodiment is configured to automatically aggregate latency and/or other performance data, including navigation and/or load timing data, to identify issues at different levels or granularities, such as a tenant level, a geographical or location level, and/or an ISP level as part of efficiently remediating any realized or potential issues.

With continuing reference to FIG. 1, while a limited number of components are shown to describe aspects of the various embodiments, it will be appreciated that the embodiments are not so limited and other configurations are available. For example, while a single server 102 is shown, the system 100 may include multiple server computers, including pre-aggregation servers, database servers, and/or aggregation servers, as well as client devices/systems that operate as part of an end-to-end computing architecture. It will be appreciated that servers may comprise one or more physical and/or virtual machines dependent upon the particular implementation.

As described further below, components of the system 100 are configured to collect, pre-aggregate, aggregate, and/or analyze client information as part of providing real or near real time reporting to customers regarding the state of an application or network. Additional components and/or features can be added to the system 100 as needed. For example, based on an identified latency, a customer may use the feedback to deploy an additional edge server in their network. As described below, components of the system 100 may be used to ascertain different user experiences and/or network conditions across multiple networks and network types serving a client or consumer base.

As shown in FIG. 1, server 102 receives information from one or more clients shown as input 104. According to an embodiment, input 104 includes performance data associated with a client while using an online service or application. For example, raw performance data can be uploaded to server 102 for processing. In one embodiment, input 104 includes information pertaining to a client experience such as loading and navigating web resources, and/or server 102 comprises a server computer that supports the use of log files to store collected data. In one embodiment, a browser or other application running on a user device/system can use script code to collect information related to one or more of navigation timing parameters, resource and/or load timing parameters, and/or custom marker parameters which may be written to a server log file. For example, server 102 can be configured as a MICROSOFT EXCHANGE server to use one or more fault-tolerant, transaction-based databases to store information.

According to an embodiment, in addition to processing and memory resources, server 102 includes extensible diagnostic features that utilize a pre-aggregator 106 that operates in part on raw performance data included with input 104, but is not so limited. The pre-aggregator 106 of an embodiment operates to parse client data stored in log files as part of extracting and mapping the client data to one or more mapping tables. In one embodiment, the pre-aggregator 106 operates to parse performance data stored in one or more log files to generate mappings, wherein the mappings are defined in part by transforming client IP address and logged client information to one or more of a geographical location (e.g., country/state), an ISP, and/or tenant global user identifier (GUID).

The pre-aggregator 106 is configured to group performance data by one or more of IP, location, ISP, and/or tenant GUID before storing the grouped information to store 108. For example, the pre-aggregator 106 can be configured to group performance data associated with client latency metrics by country/state, ISP, and/or tenant. If the logged data cannot be resolved to an ISP level, the pre-aggregator 106 can identify groups limited to country and/or tenant. It will be appreciated that country and ISP parameters can be determined according to client IP address.

As shown, the aggregation service 110 operates on the pre-aggregated output provided by pre-aggregator 106 to generate an aggregated output 112. The functionality provided by the pre-aggregator 106 operates in part to increase an efficient use of processing and memory resources at the aggregation service 110 while also reducing power consumption since a smaller data set can be input to the aggregation service 110 to generate the aggregated output 112. The aggregation service 110 of an embodiment comprises one or more server computers and complex aggregation code that operates to provide aggregated output 112. As described in more detail below, an aggregated output 112 can be further processed to identify any potential failure zones and/or other issues that may be contributing to a user experience. The aggregation service 110 of one embodiment aggregates pre-aggregated data across all databases to quantify one or more of tenant level, country level, and/or ISP level latencies associated with a particular application, service, or other component.

As described below, rules can be included with the aggregation service 110 to control processing of the pre-aggregated output to generate the aggregated output 112. Based on different rule types, the aggregated output 112 provides focus including correlations, trends, baseline comparisons, and/or other quantified information tied to a use experience during execution of an application or an online service. For example, rules can be implemented that operate on pre-aggregated data to analyze performance based on an overall value for a region, such as by deriving the 75% percentile x and the standard deviation y for a given metric for North America. If the measurement for Mexico is greater than (x+y), it may cause escalation of a potential issue to engineering staff. Additional features are described further below.

It will be appreciated that complex communication architectures typically employ multiple hardware and/or software components including, but not limited to, server computers, networking components, and other components that enable communication and interaction by way of wired and/or wireless networks. While some embodiments have been described, various embodiments may be used with a number of computer configurations, including hand-held devices, multiprocessor systems, microprocessor-based or programmable consumer electronics, minicomputers, mainframe computers, etc. Various embodiments may be implemented in distributed computing environments using remote processing devices/systems that communicate over a one or more communications networks. In a distributed computing environment, program modules or code may be located in both local and remote memory. Various embodiments may be implemented as a process or method, a system, a device, article of manufacture, etc.

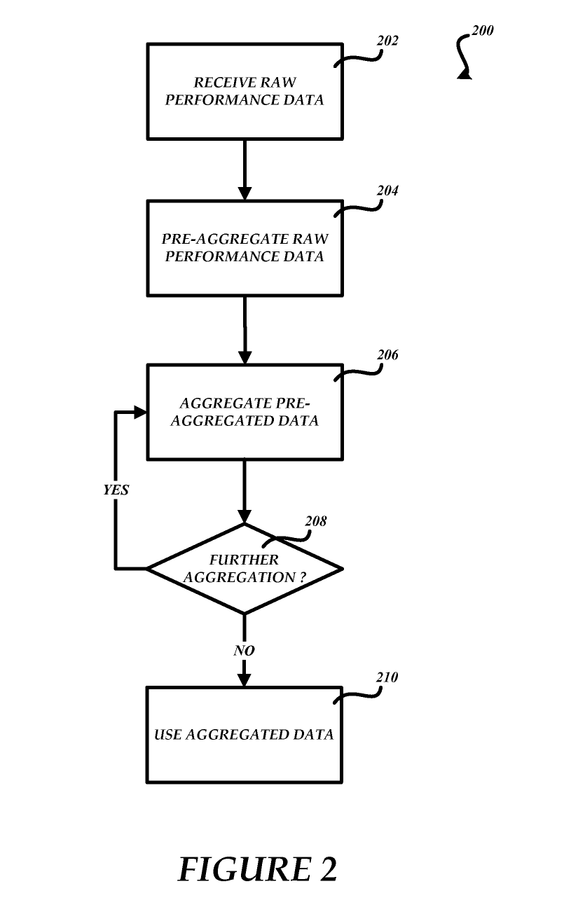

FIG. 2 is a flow diagram depicting an exemplary process 200 of pre-aggregating and aggregating performance and/or other data as part of providing performance diagnostics and/or remediation services according to an embodiment. The process 200 begins at 202 by receiving raw performance data. For example, the process 200 at 202 can operate using a server computer to receive client-centric performance data collected by a client as part of requesting an assessment of a state of an online service or application. In one embodiment, the process 200 at 202 operates to receive client performance data that includes navigation timing, page load timing, and/or other parameters to use when assessing health or user experience associated with an online service or application.

At 204, the process 200 operates to pre-aggregate the raw performance data. In one embodiment, the process 200 at 204 operates to pre-aggregate the raw performance data by parsing log files and mapping client IP addresses to one or more of tenant identifier, location identifier, and/or ISP identifier before uploading the pre-aggregated data to one or more databases for final aggregation operations. At 206, the process 200 operates to aggregate the pre-aggregated data. In one embodiment, process 200 at 206 operates to aggregate the pre-aggregated data in part by generating an output of latency or other user experience quantifiers to identify issues at one or more of a tenant level, a location level, and/or ISP level.

If there are no further aggregation operations at 208 the process 200 proceeds to 210 and uses the aggregated data for latency and/or other analysis. Otherwise, the process 200 returns to 206 and continues aggregation operations. As described above and further below, aggregated output can be used as part of remediating any identified issue by implementing contingency or other measures. While a certain number and order of operations are described for the exemplary flow of FIG. 2, it will be appreciated that other numbers, combinations, and/or orders can be used according to desired implementations.

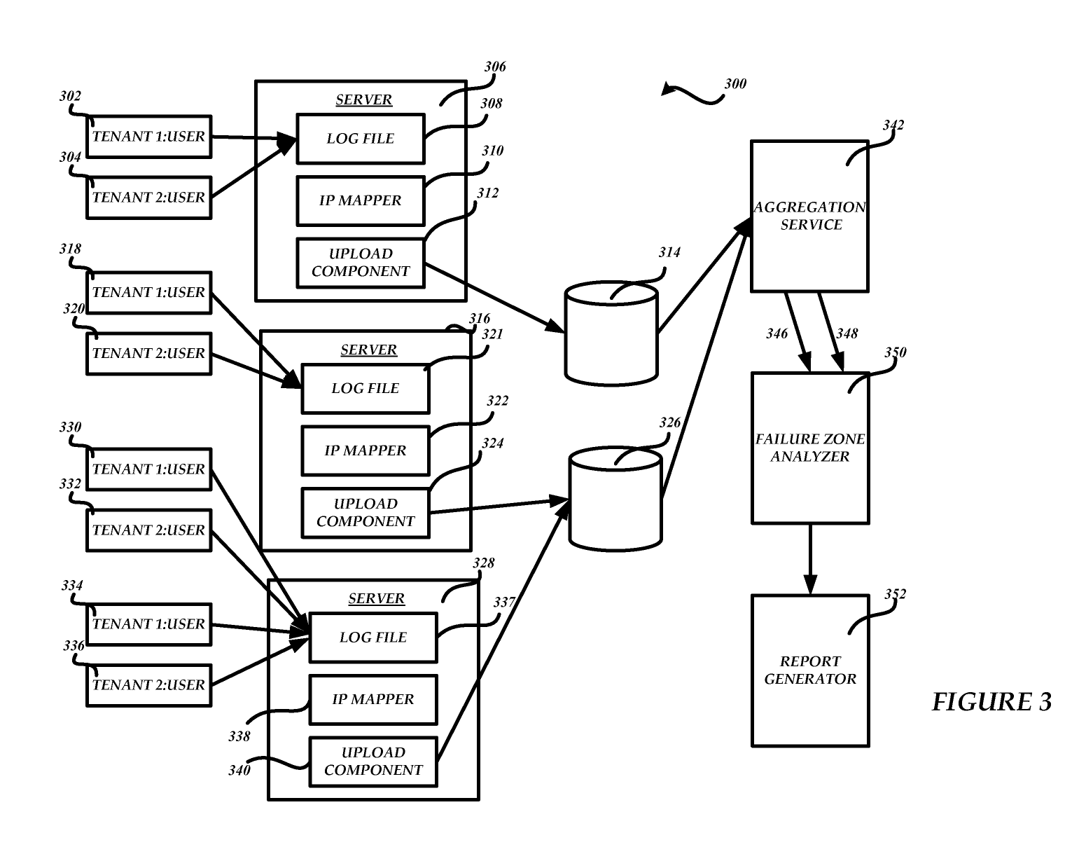

FIG. 3 is a block diagram depicting components of an exemplary end-to-end data processing pipeline 300 that operate in part to provide user insights into aggregated data as part of identifying infrastructure, performance, network, or other issues that may be adversely affecting use of an online application or service. For example, an online service supporting cloud-based application services can include functionality to collect and quantify performance data or metrics in near real time including providing user scenario latencies and detailed breakdowns by collected metrics associated with one or more of client operational parameters, tenant parameters, IP parameters, location parameters, and/or ISP parameters. Components of the pipeline 300 operate in part to aggregate, pivot, and/or store data at the tenant level, IP level, geographic location level, and/or an ISP level. Components of the pipeline 300 operate in part to proactively monitor user experiences to reduce performance degradations while providing alerts and/or solutions to remediate end user performance issues.

As shown in FIG. 3, a client 302 associated with a first tenant user and client 304 associated with a second tenant user are communicating with server 306. As shown, log file 308 receives and stores collected data from clients 302 and 304. In one embodiment, the client 302 can be implemented as part of a browser application running on a user device system, wherein script code can be used to collect information associated with use of an online application or service, such as a page load time, a time to connect, or some other parameter for example. The server 306 of one embodiment comprises a server computer dedicated to serving clients 302 and 304. According to an embodiment, server 306 includes a diagnostics service that uses an IP mapper 310 and upload component 312 for an associated node.

The IP mapper 310 and upload component 312 operate in part to provide pre-aggregation services on the data of log file 308. As described above, a single component can be configured to perform the pre-aggregation services provided by these components. The IP mapper 310 of an embodiment operates in part to parse log file 308 to extract and map logged performance data or metrics based on one or more of an IP address, a location, and/or ISP for each client or tenant. According to one embodiment, the IP mapper 310 operates in part to pre-aggregate and consolidate the client data by mapping a client IP address and performance or latency data to one or more of a geographic location (e.g., country/state), an ISP, and/or a tenant global user identifier (GUID). The upload component 312 operates to upload the mapped data provided by the IP mapper 310 grouped by one or more of location, ISP, and/or tenant GUID to a dedicated database 314. If the logged data cannot be resolved to an ISP level, the pre-aggregation can include groupings limited to country and/or tenant. It will be appreciated that country and ISP parameters can be determined according to a client IP address.

With continuing reference to FIG. 3, components of server 306 are configured with complex programming code that operates to pre-aggregate collected client data in part by parsing the collected client data, such as by parsing performance data logs for example, and extracting user scenario, time of event, client IP, latency, tenant data and other detailed metrics based on the client information. Consequently, the server 306 is able to pre-aggregate data received from client as part of reducing the final aggregation load when quantifying latency and/or other performance issues.

The IP mapper 310 of an embodiment operates to map client IP addresses to a geographic location depending on the mapping granularity and/or a client IP to an associated ISP based on known or to be implemented IP ranges. The server 306 includes analysis code that operates to parse based in part on a type of client and/or associated client data. For example, performance data of a web access client can be collected and routed to a log file of mailbox server serving the sessions, wherein the analysis code would be configured to parse the particular client information to understand a scenario, latency, and associated issues (e.g., slow navigation time, slow DNS time, etc.).

Parsing of an embodiment operates to transform client IP address and tenant information in the log files to country/state, ISP and/or tenant GUID. In one embodiment, parsing operations are performed in part using a derived mapping table generated from a generic public geo-mapping database.

An example data entry in a geo-mapping database for parsing may include:

StartIP|EndIP|CIDR|Continent|Country|Country_ISO2|CountryConfidence|Regio
n|State|State_CF|City|CityConfidence|Postal_Code|.....
16777472|16778239|24|asia|china|cn|8||beijingshi|73|beijing|5|100000|0|8|39.9117
6055|116.3792325|0|0|0|unknown||none|False|0|0|0|1307256208|0|RT_Unknown
16778240|16779263|24|oceania|australia|au|8||victoria|74|melbourne|5|3000|0|10|-
37.8132|144.963|0|0|0|unknown||none|False|56203|7482486|440|1312156419|1312378472|RT
_Unknown

The parsing operations applied by the IP mapper 310 of an embodiment result in the generation of a derived mapping table for IP to Countries by scanning each data entry, sorting, and merging based on IP ranges and corresponding countries to yield:

16777216,au

16777472,cn

16778240,au

16779264,cn

16781312,jp

16785408,cn

16793600,jp

16809984,th

16842752,cn

A mapping table can include exemplary mapping {key,value} data. As shown above, the mapped data includes a key that is an integer value that represents a starting IP address and a value that is the country ISO code. In the above mapping data, IP addresses between 16777216 and 16777472 belong to AU. By sorting the keys, the table can be compressed for loading into memory for quick look-up.

Similarly, parsing operations applied by the IP mapper 310 of an embodiment result in the generation of a derived mapping table for an IP to ISP mapping as shown below (key is the same as above but the value is an ASN number of an ISP):

17498112,18313

17514496,38091

17522688,38669

17530880,17839

17563648,18245

With continuing reference to FIG. 3, and continuing the example, server 316 processes or pre-aggregates client data of clients 318 and 320 stored in log file 321 in part by using the IP mapper 322 and upload component 324 to process and upload pre-aggregated data to another dedicated database 326. Dedicated databases 314 and 326 may or may not include more than one host computer. Moreover, while certain numbers and types of components are shown, it will be appreciated that the pipeline can include additional components, features, and functionality. Server 328 processes client data of clients 330, 332, 334, and 336 stored in log file 337 in part by using the IP mapper 338 and upload component 340 to process and upload pre-aggregated data to dedicated database 326.

In an embodiment, databases 314 and 326 are designed to handle the performance counters and metrics collected from various machines that may be networked to provide an online application or service. Since the end user performance data brings in additional pivots, a database schema can be used to support IP, geographic location, tenant, and/or ISP metrics and parameters. In one embodiment, server 306, server 316, and server 328 collect client data from a plurality of clients. For example, at the node level, server 306 can operate to pre-aggregate client data every 5 minutes using IP mapper 310 to transform the client data into predetermined pivots and the upload component 316 propagates the transformed data to database 314.

Aggregation service 342 aggregates the pre-aggregated data across databases 314 and 326 to determine one or more of tenant level latencies, country level latencies, and/or ISP level latencies associated with an online application or service, but is not so limited. For example, the aggregation service 342 operates on the pre-aggregated or transformed data to perform scope (Global and/or Site for example) level conversion on the node level data for end user metrics. As shown by example in FIG. 3, the aggregation service 342 has provided an aggregated output that includes quantified client performance data 346 associated with the first tenant and quantified client performance data 348 associated with the second tenant. A number of sample counts can be used as a weighting factor to improve statistical accuracy of the quantified client performance data.

The aggregation service 342 can be configured to aggregate pre-aggregated data uploaded from one of more upload components at defined time intervals (e.g., run every 15 min., use for a sliding window of last 1 hour of data; run every 24 hours, use sliding window of last 24 hours of data, etc.). The aggregation service 342 can also be configured to pivot or group, across one or more domain controllers, by geographic location, tenant, ISP per geographic location, tenant per geographic location, and/or scope per site level. The aggregation service 342 operates in part to generate client scenario latency and other performance related statistics for quantifying navigation time, CDN time, authorization time, redirect time, etc. For example, the aggregation service 342 can provide statistical measures/values such as average, 75% percentile, 85% percentile, 95% percentile, etc. The aggregation service 342 can also use dynamic bins that encompass a range of latencies with percentile values for latencies at 10th, 20th, 30th, 40th, 50th, 60th, 70th, 80th, 90th percentiles, and maximum.

Failure zone analyzer 350 operates in part using rules that are designed to identify certain segments or characteristics of the data aggregate using statistical measures or other latency quantifications. For example, the rules may be designed to identify different levels of performance (e.g., fair, poor, excellent, etc.) based on one or more quantitative measures, such as navigation time, load time, connect time, etc. The rules are applied to the aggregated data according to the output from the aggregation service 342. Exemplary rules are configurable according to each implementation. For example, rules may be based on an overall value for a region or ISP such as rules configured to prioritize consideration of certain metrics or measures over others.

Report generator 352 operates to generate report information for reporting and/or feedback communications as to the state of an application or service along with any specific recommendations for tenants having some identified issue that may need to be addressed. For example, report generator 352 can operate to dynamically generate a user insight report that lists the top number (e.g., 10) tenants for each geographic location having highest latencies or the top number of tenants having the highest latencies. While shown as integral components, it will be appreciated that failure zone analyzer 350 and report generator 352 can be configured as separate components. In an alternative embodiment, pivots can be applied solely at the aggregation service 342, or in combination with pivots applied the server 306, server 316, and/or server 328.

The pipeline 300 of an embodiment uses performance markers as part of: reliably collecting client data; allowing segregation of successful and failed execution of scenario; allowing for filtering/segregation of monitoring data (e.g., probes); accurately marking the start and end of scenarios tied with user experience (e.g., navigation time, page load, page displayed, page interactive, etc.); and/or identifying and filling missing data to assist with detailed drill downs, such as time to complete authentication, time to download CDN resources, time to redirect to correct web-access server, etc.

Navigation timing of one embodiment comprise calculated values based on each time stamp defined in the W3C Navigation Timing API. To address the need for complete information on user experience, the W3C Navigation Timing API introduces the performance timing interface allowing JAVASCRIPT mechanisms to provide complete client-side latency measurements within applications. The interface can be used to measure a user's perceived page load time. Resource timing markers of one embodiment are the calculated values based on each time stamp defined in the W3C Resource Timing API that defines an interface allowing JAVASCRIPT mechanisms to provide complete client-side latency measurements within applications. The interface can be used to measure a user's perceived load time of a resource.

The Table below provides exemplary markers, marker calculations, and the associated descriptions in accordance with one embodiment.

| | How marker is | |
|---|---|---|
| Markers | calculated | Description |
| Redirect Time | RedirectEnd - | The total time taken by all |
| | RedirectStart | redirects, if redirect exists. |
| Fetch Time | ResponseEnd - | The entire time taken to |
| | FetchStart | fetch a response from a |
| | | server. |
| Domain Lookup | DomainLookupEnd - | The time taken to resolve |
| Time | DomianLookupStart | the DNS. |
| Connect Time | ConnectEnd - | The time taken to make |
| | ConnectStart | the first TCP connection. |
| Secure Connect | ConnectEnd - | The time taken to make |
| Time | SecureConnectStart | the secure connection. |
| Request Time | ResponseStart - | The time taken by the |
| | RequestStart | request to come back |
| | | from a server. |
| Response Time | ResponseEnd - | The time taken to receive |
| | ResponseStart | the response body. |
| Unload Event | UnloadEventEnd - | The time taken to unload |
| | UnloadEventStart | previously loaded content. |
| DOM Load Time | DomComplete - | The time taken from when |
| | DomLoading | an onreadystate transitions |
| | | from “loading” to “complete”. |
| Total Navigation | LoadEventEnd - | The time taken from start |
| Time | NavigationStart | of a page to the complete |
| | | load event of a document |

Other exemplary markers may include:

Page load time (PLT)—The PLT time without authentication time, this key only appear when “type” is PLT (boot from no-cache or browser cache).

ALT—The PLT time without authentication time, this key only appear when “type” is ALT (boot from application cache).

RDT—The render time from web access finish retrieve session data until PLT end marker.

For the examples below, client raw data includes parameters including but not limited to:

Redirect Count (RC);

Redirect Time (RT);

Fetch Time (FT);

Domain Lookup Time (DN);

Connect Time (CT);

Secure Connect Time (ST);

Request Time (RQ);

Response Time (RS);

Total Response Time (TR);

Dom Load Time (DL); and

Total Navigation Time (NV).

As an example log file 308 can include the following web-access navigation timing raw data associated with client 302 as:

20XX -01-
09T00:08:12.304Z,W3CNavTimeTestBox,PerfNavTime,S:mg=<<Tenant ID>>;S:ts=20XX -
01-09T00:08:03.860;
S:UC=5f8a321a877591c42b7;I32:ds=132;I32:DC=1;S:Mowa=0;S:ip=<PII> IP
Address</PII>;
S:tg=D73DD084-BF81-4F05-A0D0-B8599C0444D0;S:user=<PII>Username
like user1@contoso.com<PII>;
S:cbld=15.0.609.0;S:BuildType=DEBUG;
S:URI=<<Server
URI>>;S:FT=12;S:DN=0;S:CT=0;S:RQ=0;S:RS=10;S:UL=5;S:NV=5000;S:DL=2000;
S:D1=1078;S:D2=1760;
S:DE=5;S:PL=2;S:RC=0;S:NT=1.

And navigation timing raw data associated with client 304 as:

20XX -01-
09T00:08:12.304Z,W3CNavTimeTestBox,PerfNavTime,S:mg=<<Tenant ID>>;S:ts=20XX -
01-
09T00:08:04.860;S:UC=f8a321a877591c42b7;I32:ds=132;I32:DC=1;S:Mowa=0;S:ip=<PII>
IP Address</PII>;
S:tg=D73DD084-BF81-4F05-A0D0-B8599C0444D0;S:user=<PII> Username
like user1@contoso.com</PII>;
S:cbld=15.0.609.0;S:BuildType=DEBUG;
S:URI=<<Server
URI>>;S:FT=20;S:DN=1;S:CT=10;S:RQ=10;S:RS=10;S:UL=15;S:NV=6000;S:DL=4000;
S:D1=2156;S:D2=3000;
S:DE=10;S:PL=3;S:RC=2;S:NT=1.

Exemplary load timing raw data associated with client 302 as:

20XX -05-
30T08:02:12.304Z,ClientLoadTimeTestBox,CalculatedClientLoadTime,
S:ts=20XX -05-30T08:02:16.20XX
727Z;S:UC=411e478fdfef403c9a28c1c3ffaa0317;
S:ip=<PII>IP Address</PII>;S:tg=1a3ba9c6-00d3-4c2e-9862-f08a05a11f1f;
S:PLT=7000;S:RDT=4000;S:RT=18;S:DN=0;S:CT=0;S:RQ=1188;S:RS=2;S:SD
N=0;S:SCT=10;S:SRQ=1800;
S:SRS=300;S:R1DN=0;S:R1CT=200;S:R1ST=100;S:R1RQ=50;S:R1RS=10;S:R
2DN=0;S:R2CT=8;S:R2ST=0;
S:R2RQ=50;S:R2RS=200;S:brn=MSIE;S:brv=10;

And, load timing raw data associated with client 304 as:

20XX--05-
30T08:02:12.304Z,ClientLoadTimeTestBox,CalculatedClientLoadTime,
S:ts=20XX -05-30T08:03:16.20XX
727Z;S:UC=412e478fdfef403c9a28c1c3ffaa0317;
S:ip=<PII>IP Address</PII>;S:tg=1a3ba9c6-00d3-4c2e-9862-
f08a05a11f1f;S:PLT=8000;S:RT=18;S:DN=0;S:CT=0;S:RQ=1188;S:RS=2;S:SDN=100;S:S
CT=50;S:SRQ=1600;
S:SRS=400;S:R1DN=0;S:R1CT=600;S:R1ST=300;S:R1RQ=90;S:R1RS=50;S:R
2DN=0;S:R2CT=16;S:R2ST=0;
S:R2RQ=0;S:R2RS=400;S:brn=Chrome;S:brv=27.

Using the exemplary client data, the Table below shows exemplary output from aggregation service 342 aggregating user performance data by tenant and by country as follows.

Sample Tenant Aggregates

| Start | End | Agg. | | | | | | | | Sample |
|---|---|---|---|---|---|---|---|---|---|---|
| Time | Time | Time | Tenant | Metric | Min | Max | 75^{th} | 85^{th} | 95^{th} | Count |
| 09/17/ | 09/18/ | 09/18/ | Tenant12 | OWA W3C | 0 | 0 | 0 | 0 | 0 | 1 |
| 20XX | 20XX | 20XX | | Navigation | | | | | | |
| 23:00 | 00:00 | 00:00 | | Timing\Connect | | | | | | |
| | | | | Time | | | | | | |
| 09/17/ | 09/18/ | 09/18/ | Tenant14 | OWA W3C | 293 | 58354 | 2840 | 3249 | 5749 | 49 |
| 20XX | 20XX | 20XX | | Navigation | | | | | | |
| 23:05 | 00:05 | 00:05 | | Timing\Connect | | | | | | |
| | | | | Time | | | | | | |
| 09/17/ | 09/18/ | 09/18/ | Tenant19 | OWA W3C | 419 | 8833 | 2529 | 2805 | 5370 | 26 |
| 20XX | 20XX | 20XX | | Navigation | | | | | | |
| 23:10 | 00:10 | 00:10 | | Timing\Connect | | | | | | |
| | | | | Time | | | | | | |

Sample Country Aggregates

| Start | End | Agg. | | | | | | | | Sample |
|---|---|---|---|---|---|---|---|---|---|---|
| Time | Time | Time | Country | Metric | Min | Max | 75^{th} | 85^{th} | 95^{th} | Count |
| 09/17/ | 09/18/ | 09/18/ | US | OWA W3C | 90 | 312 | 90 | 90 | 90 | 2 |
| 20XX | 20XX | 20XX | | Navigation | | | | | | |
| 23:00 | 00:00 | 00:00 | | Timing\Connect | | | | | | |
| | | | | Time | | | | | | |
| 09/17/ | 09/18/ | 09/18/ | US | OWA W3C | 23.5 | 5741 | 413 | 550 | 3775 | 58 |
| 20XX | 20XX | 20XX | | Navigation | | | | | | |
| 23:05 | 00:05 | 00:05 | | Timing\Connect | | | | | | |
| | | | | Time | | | | | | |
| 09/17/ | 09/18/ | 09/18/ | US | OWA W3C | 18.33 | 10353 | 553 | 701 | 1537 | 64 |
| 20XX | 20XX | 20XX | | Navigation | | | | | | |
| 23:10 | 00:10 | 00:10 | | Timing\Connect | | | | | | |
| | | | | Time | | | | | | |

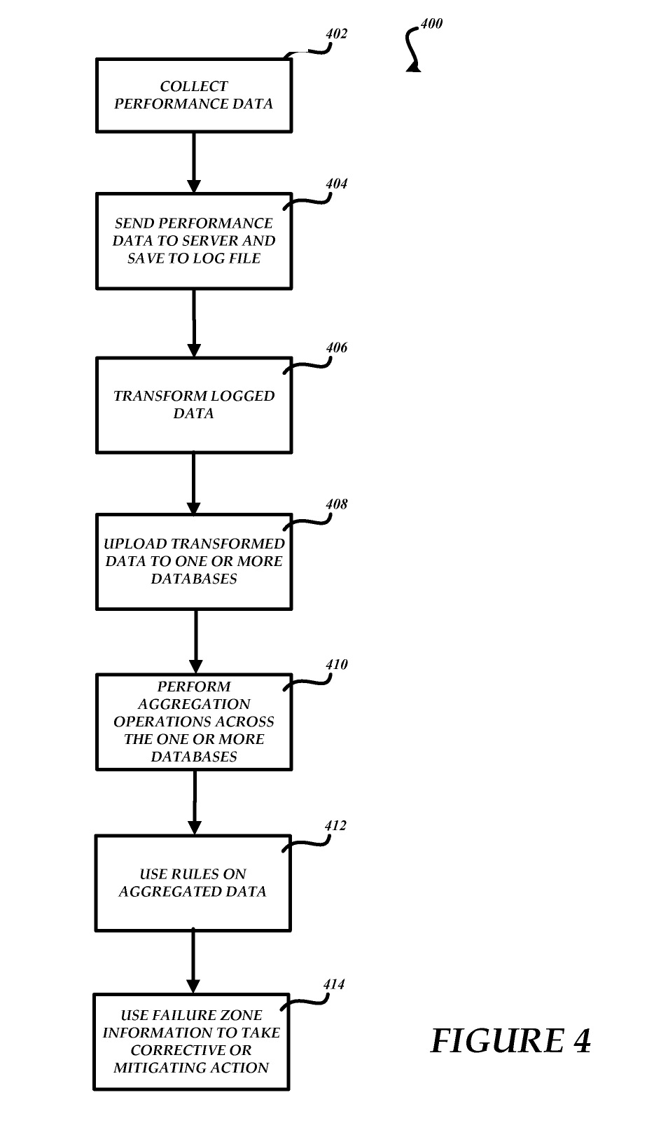

FIG. 4 is flow diagram depicting operations of an exemplary end-to-end process 400 used as part of providing performance diagnostic analysis and/or issue remediation services according to an embodiment. The process 400 at 402 operates to collect performance data using a client executing on an end-user device/system. For example, at 402, a client such as a browser or other application and scripting code (e.g., JAVASCRIPT code) collects client-centric performance data and/or requests performance diagnostic analysis services from one or more server computers associated with use an online of service or application. The process 400 at 402 of one embodiment operates to collect raw performance data that includes navigation timing, page load timing, and/or other parameters indicative of latencies or other performance issues as part of assessing an end-user experience associated with an online service or application.

The process 400 at 404 operates to provide the raw performance data to a log file of a dedicated server computer. For example, the process 400 at 404 includes the use of a browser executing on a user device/system to upload a client IP address and collected performance data or some portion to one or more log files. At 406, the process 400 operates to transform or map the logged performance data using the client IP address and mapping targets that include geographical location (e.g., country/state), ISP, and/or tenant GUID. For example, the process 400 at 406 can be configured to map logged client data to a plurality of mapping tables including a first mapping table that defines IP address to geographic location mappings for the logged client data and a second mapping table that defines IP address to ISP mappings for the logged client data.

At 408, the process 400 operates to upload the transformed data grouped by one or more of tenant GUID, geographic location, and/or ISP to one or more diagnostic service databases. The process 400 at 410 operates to perform aggregation operations across the one or more databases to generate latency and/or other performance related aggregations for the online service or application. In one embodiment, the process 400 at 410 performs aggregation operations to determine one or more of tenant level, geographic location level, and/or ISP level latencies.

The process 400 at 412 uses one or more rules on the aggregated data to perform a failure zone analysis to identify one or more failure or potential failure zones. For example, the process 400 at 412 can use configured rules to vet whether a user experience is poor, satisfactory, or excellent based in part on trend or baseline comparisons across all countries and/or ISPs. At 414, the process 400 operates to use the failure zone information as part of taking any corrective or mitigating action. For example, the process 400 at 414 can use failure zone analysis information to generate online reports that identify potential network and/or communication architecture modifications as part of reducing latency or other performance related issues. While a certain number and order of operations are described for the exemplary flow of FIG. 4, it will be appreciated that other numbers, combinations, and/or orders can be used according to desired implementations.

For example, the process 400 can be used in part to generate an electronic report that allows for viewing of different network metrics for an online email service to identify that users in a first location are spending longer time in CDN compared to rest of the countries in the associated region. A reviewer can then follow-up with a CDN provider in the first location to resolve the issue. Additionally, review of a geographic-ISP report for the first location reveals difference in latencies by ISP enabling ready identification of an increase in latency for one of the larger ISPs that may be contacted to inform and resolve the issue.

As yet another example, as part of an edge server deployment, the process 400 can be used to generate an electronic report that includes download times by region to identify users of a particular region having maximum download time resulting in deploying of a new edge server to reduce the impact of user networks. An updated report reveals a reduction in latencies for the particular region. As another example, of reducing identifying latencies, the process 400 can generate an electronic report that allows a particular tenant to display a trend view and determine that a latency increase occurred in the last few days as well as TCP connecting times increased by 500 ms. Based on the report, an affected tenant can be contacted to identify issues with ISP peering with another location.

It will be appreciated that various features described herein can be implemented as part of a processor-driven environment including hardware and software components. Also, while certain embodiments and examples are described above for illustrative purposes, other embodiments are included and available, and the described embodiments should not be used to limit the claims. Suitable programming means include any means for directing a computer system or device to execute steps of a process or method, including for example, systems comprised of processing units and arithmetic-logic circuits coupled to computer memory, which systems have the capability of storing in computer memory, which computer memory includes electronic circuits configured to store data and program instructions or code.

An exemplary article of manufacture includes a computer program product useable with any suitable processing system. While a certain number and types of components are described above, it will be appreciated that other numbers and/or types and/or configurations can be included according to various embodiments. Accordingly, component functionality can be further divided and/or combined with other component functionalities according to desired implementations. The term computer readable media as used herein can include computer storage media or computer storage. The computer storage of an embodiment stores program code or instructions that operate to perform some function. Computer storage media can include volatile and nonvolatile, removable and non-removable media implemented in any method or technology for storage of information, such as computer readable instructions, data structures, program modules, etc.

System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components which include, but are not limited to, wide area networks (WANs), local area networks (LANs), metropolitan area networks (MANs), proprietary networks, backend networks, cellular networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions.

Terms used in the description, such as component, module, system, device, cloud, network, and other terminology, generally describe a computer-related operational environment that includes hardware, software, firmware and/or other items. A component can use processes using a processor, executable, and/or other code. Exemplary components include an application, a server running on the application, and/or an electronic communication client coupled to a server for receiving communication items. Computer resources can include processor and memory resources such as: digital signal processors, microprocessors, multi-core processors, etc. and memory components such as magnetic, optical, and/or other storage devices, smart memory, flash memory, etc. Communication components can be used to communicate computer-readable information as part of transmitting, receiving, and/or rendering electronic communication items using a communication network or networks, such as the Internet for example. Other embodiments and configurations are included.

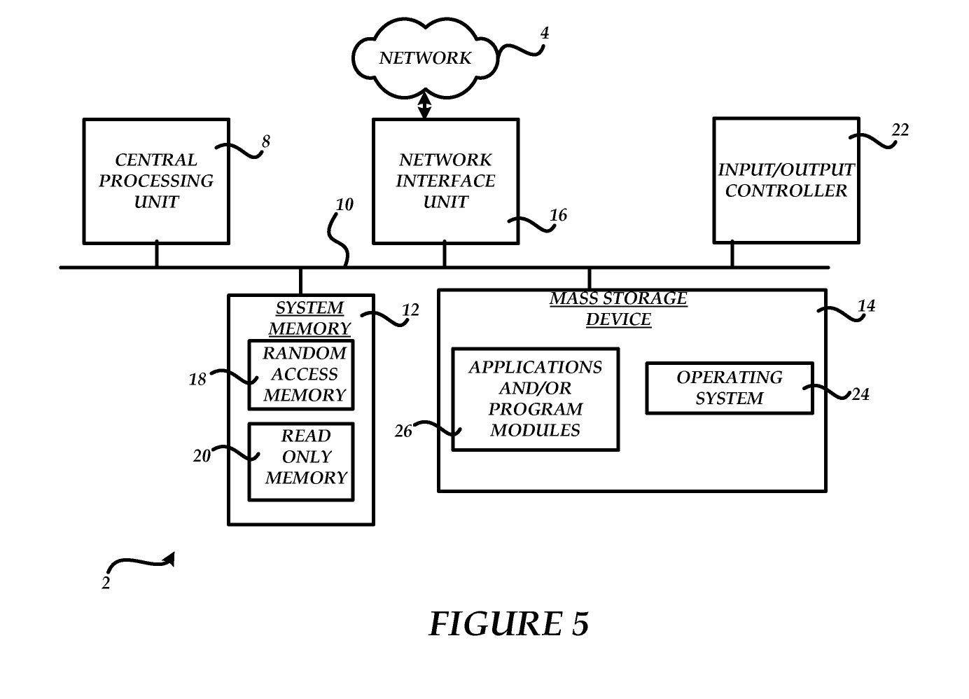

Referring now to FIG. 5, the following provides a brief, general description of a suitable computing environment in which embodiments be implemented. While described in the general context of program modules that execute in conjunction with program modules that run on an operating system on various types of computing devices/systems, those skilled in the art will recognize that the invention may also be implemented in combination with other types of computer devices/systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 5, computer 2 comprises a general purpose server, desktop, laptop, handheld, or other type of computer capable of executing one or more application programs including an email application or other application that includes email functionality. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

According to various embodiments, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

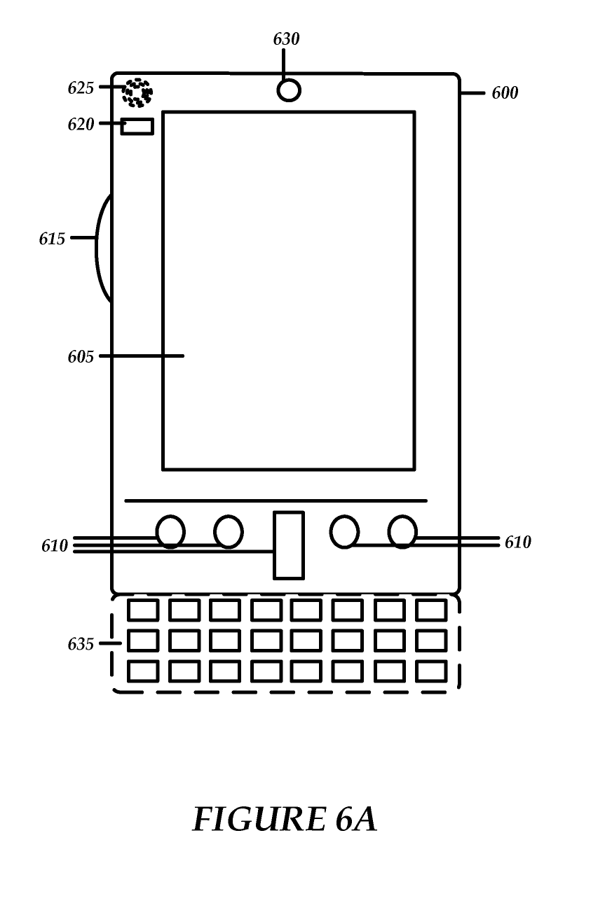

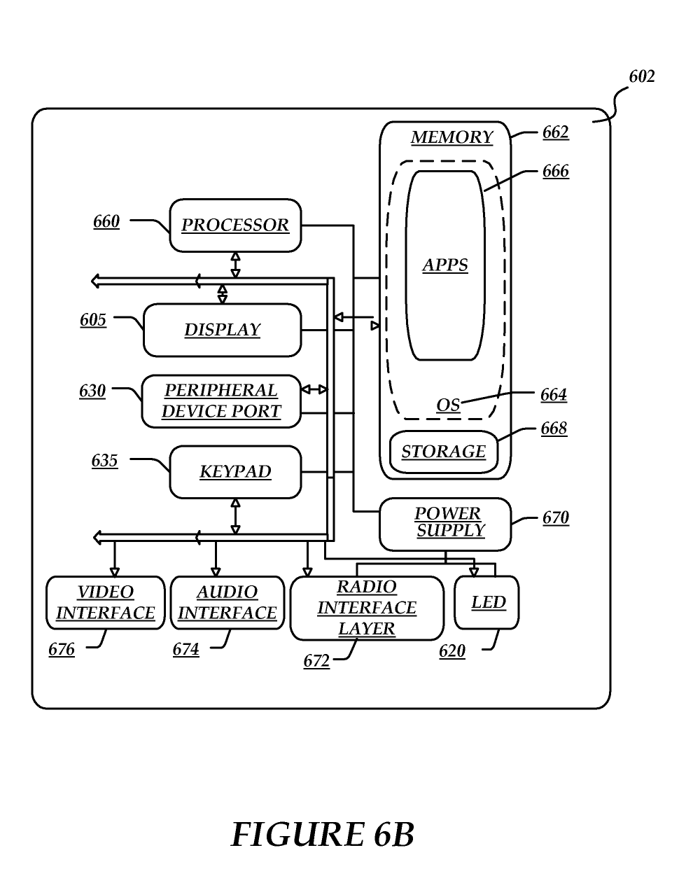

FIGS. 6A-6B illustrate a mobile computing device 600, for example, a mobile telephone, a smart phone, a tablet personal computer, a laptop computer, and the like, with which embodiments may be practiced. With reference to FIG. 6A, one embodiment of a mobile computing device 600 for implementing the embodiments is illustrated. In a basic configuration, the mobile computing device 600 is a handheld computer having both input elements and output elements.

The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone.

The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 666, including a notes application, may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down.

The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries. The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device.

The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments, the microphone may also serve as an audio sensor to facilitate control of notifications, as will be described below. The system 602 may further include a video interface 676 that enables an operation of an on-board camera 630 to record still images, video stream, and the like. A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

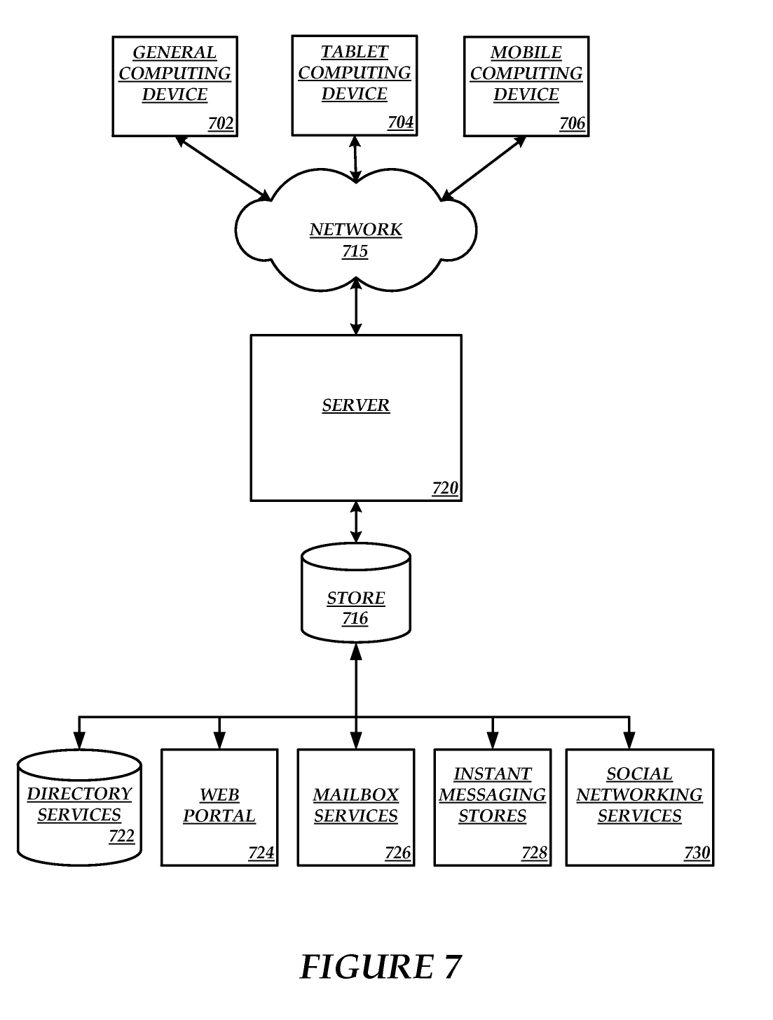

FIG. 7 illustrates one embodiment of a system architecture for implementing latency identification and remediation features. Data processing information may be stored in different communication channels or storage types. For example, various information may be stored/accessed using a directory service 722, a web portal 724, a mailbox service 726, an instant messaging store 728, and/or a social networking site 730. A server 720 may provide additional latency analysis and other features. As one example, the server 720 may provide rules that are used to distribute outbound email using a number of datacenter partitions over network 715, such as the Internet or other network(s) for example. By way of example, the client computing device may be implemented as a general computing device 702 and embodied in a personal computer, a tablet computing device 704, and/or a mobile computing device 706 (e.g., a smart phone). Any of these clients may use content from the store 716.

Embodiments, for example, are described above with reference to block diagrams and/or operational illustrations of methods, systems, computer program products, etc. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

It should be appreciated that various embodiments can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A system configured to:
receive user performance data from a plurality of clients as part of analyzing a state of an online service or application;
pre-aggregate the user performance data of the plurality of clients in part using a client Internet Protocol (IP) address and tenant information associated with the performance data to provide mapped data that includes mappings between client IP addresses and one or more of a location parameter, a service provider parameter, and tenant globally unique identifier (GUID) parameter; and
aggregate the mapped data in part to generate aggregated data to identify one or more of a tenant level issue, a location level issue, and an ISP level issue.

2. The system of claim 1, further configured to collect client data at each node to reduce processing time by limiting of a number of data points used with final aggregation operations.

3. The system of claim 1, further configured to apply a number of rules to the aggregated data as part of performing failure zone analysis.

4. The system of claim 3, further configured to provide a report associated with mitigating or resolving a performance issue for one or more tenants.

5. The system of claim 1, further configured to collect the performance data using a server log file including one or more of navigation timing data, resource or load timing data, and custom markers.

6. The system of claim 1, further configured to group latency metrics by one or more of a location class, an Internet Service Provider (ISP) class, and a tenant class.

7. The system of claim 1, further configured to generate one or more mapping tables using one or more key-value pairs, wherein a first key-value pair comprises a key comprising an integer that represents a starting IP address and a value for the key is a country code parameter.

8. The system of claim 7, further configured to generate the one or more mapping tables using the one or more key-value pairs, wherein a second key-value pair comprises a key comprising an integer that represents a starting IP address and a value for the key is an autonomous system number (ASN) number associated with an ISP.

9. The system of claim 1, further configured to generate an aggregated output for a number of performance metrics associated with one or more of a tenant, a country, and an ISP, wherein the aggregated output includes a minimum value, a maximum value, and one or more percentile values.

10. The system of claim 1, further configured to provide aggregation services by pulling client performance data globally and aggregating based on a set of common or customized metrics.

11. The system of claim 10, further configured to pre-aggregate the performance data at each node before performing a final aggregation to reduce an amount of processing resources used while aggregating.

12. An article of manufacture configured with instructions that operate to provide aggregation features by:
receiving client data including navigation timing and load timing metrics;
transforming the client data to mapped data using one or more mapping tables;
uploading the mapping tables and mapped data to one or more databases; and
aggregating the mapped data across the one or more databases to quantify one or more tenant level latencies, location level latencies, and ISP level latencies.

13. The article of manufacture of claim 12 configured with instructions that operate to provide aggregation features further by performing scope level conversion on node level data for end user metrics.

14. The article of manufacture of claim 12 configured with instructions that operate to provide aggregation features further by generating an aggregated output associated with one or more of a tenant, a country, and an ISP.

15. The article of manufacture of claim 12, wherein the one or more mapping tables include an IP address to country mapping table and an IP address to ISP mapping table.

16. The article of manufacture of claim 12 configured with instructions that operate to provide aggregation features further by reporting remediation information in part to mitigate or resolve an identified latency issue.

17. A method comprising:
collecting performance metrics for a plurality of clients, wherein the performance metrics are associated with a state of an online service or application;
pre-aggregating the performance metrics of the plurality of clients to provide transformed data in part by generating mappings associated with an IP address to country mapping and an IP address to ISP mapping; and
aggregating the transformed data to provide aggregated data and identify one or more of tenant level latencies, location level latencies, and ISP level latencies.

18. The method of claim 17, further comprising identifying failure or potential failure zones associated with the aggregated data.

19. The method of claim 17, further comprising resolving a latency-related issue based on the failure zone analysis.

20. The method of claim 17, further comprising resolving any identified performance degradation.
